(19) United States
(12) Patent Application Publication
(10) Pub. No.: US 2025/0316794 A1
(43) Pub. Date: Oct. 9, 2025

(54) BATTERIES PROVIDED WITH A THERMAL MANAGEMENT SYSTEM COMPRISING PHASE-CHANGE MATERIALS

(71) Applicant: UNIVERSITE PARIS-EST CRETEIL VAL DE MARNE, Créteil (FR)

(72) Inventors: Mustapha KARKRI, Villejuif (FR); Mahamadou ABDOU TANKARI, Créteil (FR)

(21) Appl. No.: 18/863,239

(22) PCT Filed: May 9, 2023
(86) PCT No.: PCT/EP2023/062286

§ 371 Date: Nov. 15, 2024

(30) Foreign Application Priority Data
May 10, 2022 (FR) FR2204443

(51) Int. Cl. H01M 10/659; B60L 50/60; H01M 10/613; H01M 10/625; H01M 10/643; H01M 10/653; H01M 50/213

(52) U.S. Cl. CPC H01M 10/659; H01M 10/613; H01M 10/625; H01M 10/643; H01M 10/653; H01M 50/213; B60L 50/60; H01M 2220/20

(57) ABSTRACT

A battery comprising one or more electrochemical cells and solid-liquid phase-change material composites, the battery comprising a plurality of modules, each having a given composite, the modules having an individual configuration, in which each module has an opening used to surround part of a cell inserted into the opening, a cell being surrounded along its height by a plurality of individual modules stacked on top of one another, with at least two modules having different composites, this individual configuration being implemented for one or more cells, and/or having a collective configuration, in which each collective module has a plurality of openings used to surround part of a plurality of cells inserted into the openings, the cells being surrounded along their height by a plurality of horizontal collective modules stacked on top of one another, with at least two modules having different composites.

The invention relates to the technical field of batteries, and can relate to any type of battery, in particular, for example, lithium-ion (Li-ion) batteries.

The batteries can be, for example, batteries for energy storage systems, telecom devices, space devices, renewable energy devices, electronic devices such as power inverters, electric vehicles, etc.

The invention is particularly suited to electric vehicle batteries.

What is meant by electric vehicle is in particular vehicles equipped with an electric motor and a battery (BEV, battery electric vehicle), rechargeable hybrid vehicles equipped with an internal combustion engine and an electric motor, the battery of which can be recharged by connecting to an external electricity source (PHEV, plug-in hybrid electric vehicle). Electric vehicle refers here to two-wheel or four-wheel vehicles, scooters, passenger cars, commercial vehicles and public transport vehicles such as buses.

Lithium-ion (Li-ion) batteries are currently the most widely used in electric vehicles. A Li-ion battery is a set of Li-ion cells connected in series or in parallel in modules. The cells can be cylindrical, prismatic or pouch-like (pouch cells). Recent advances in lithium-ion batteries have led to a sharp reduction in battery prices and an increase in range.

To increase the range of electric vehicles, manufacturers have increased the energy stored on board by increasing the size of the battery pack or by increasing the energy density of the batteries, which today can reach 60 kWh, and between 80 kWh and 100 kWh in certain top-of-the-range models. The range of electric vehicles varies according to the vehicle and driving conditions, but the energy densities of the batteries mean that they can be driven for at least 200 km in all cases, whereas most everyday vehicle use does not exceed 100 km.

To reduce charging times, manufacturers are increasing the power of chargers, from 100 kW to 400 kW, which translates into charging rates ranging from 1.5 C to 10 C at battery cell level. However, charging currents are limited by cell operating mechanisms, in particular thermal effects and aging. Above a certain rate, increasing the charging current can cause the cell to heat up rather than reduce charging time. Fast charging can lead to degradation of lithium-ion cells through various mechanisms, including lithium plating, electrolyte degradation via the growth of a passive layer (solid electrolyte interphase), and mechanical degradation of the electrodes.

Rising temperatures in Li-ion batteries can also lead to thermal runaway in one of the cells of the battery, with a domino effect on the other cells. Thermal runaway manifests as a rise in cell temperature, which accelerates exothermic reactions, causing a further increase in the internal temperature of the cell, with the risk of liquid electrolyte leakage, release of chemical substances, fire or explosion.

Lead-acid batteries are widely fitted to vehicles in the rail, automotive, aircraft and satellite industries. A lead-acid battery is a set of lead-sulfuric acid cells connected in series. Lead-acid batteries are also very sensitive to extreme temperatures. In hot weather, they give off more energy than in a normal temperature range. Heat causes electrolyte loss in the battery, leading to increased discharge and eventual failure.

Battery temperature control is therefore very important, and is ensured by battery thermal management systems (BTMS), which can be classified according to two main families: active management systems and passive management systems.

Hybrid thermal management systems are also known, comprising both passive and active means. BTMSs can also be classified according to five categories, depending on the cooling means used: air, liquid, phase-change material (PCM), heat pipe, refrigerant compound. A power supply is required for active management systems, using forced convection or circulation of a heat transfer liquid.

The invention relates more particularly to battery thermal management systems using solid-liquid or solid-solid PCMs.

A review of PCMs considered for battery thermal management was presented in 2020 by Liu et al. (Phase Change Materials Application in Battery Thermal Management System: A Review, Materials 2020, 13, 4622).

The thermal state of a battery depends on the individual thermal behavior of each cell and the collective thermal behavior of all of the cells of the battery.

Technical solutions currently exist but they are not satisfactory, since they are based on a plate exchanger with the flow of a heat transfer fluid, which does not take into account the individual behavior of each cell.

For example, Bloch et al. (Batteries Li-ion, du present au futur [Li-ion Batteries, now and into the future], EDP 2020), thermal management systems for motor vehicle batteries using PCMs exist only as prototypes, while the BTMSs of motor vehicles on the market use other thermal management means, such as air cooling or cooling via contact with a liquid circulating in a cold plate.

The invention aims to solve this first main technical problem.

It also aims to solve the second technical problem described below, when the phase-change material is a solid-liquid phase-change material.

El Idi et al. propose the use of a paraffin RT27/aluminum foam composite (Hybrid cooling based battery thermal management using composite phase change materials and forced convection, Journal of Energy Storage, 2021, 102946), or the use of a composite based on paraffin RT27 and aluminum, nickel or copper foam (A numerical investigation of the effects of metal foam characteristics and heating/cooling conditions on the phase change kinetic of phase change materials embedded in metal foam, Journal of Energy Storage, Elsevier, 2019, 26; A passive thermal management system of Li-ion batteries using PCM composites: Experimental and numerical investigations, International Journal of Heat and Mass Transfer Volume 169, April 2021, 120894).

Zhengyuan et al. propose the use of a paraffin/expanded graphite composite in a battery thermal management system (BTMS) that also comprises cooling via the circulation of water through micro-channels (Thermal performance of thermal management system coupling composite phase change material to water cooling with double s-shaped micro-channels for prismatic lithium-ion battery, Journal of Energy Storage, 2022, 103490).

Liquid-solid PCMs offer the possibility of storing and releasing large amounts of heat during the phase-change process, in small volumes.

However, liquid-solid PCMs have a number of drawbacks, complicating their use in battery thermal management systems. The main drawbacks of PCMs are their low thermal conductivity, the significant risk of liquid PCM leaking into the battery, the need for PCM regeneration (solidification), and the difference in the volume of the PCM as it changes phase. Moreover, the use of a PCM increases the weight and cost of the battery.

### Invention

The aim of the present invention is to provide a battery thermal management system that does not have the drawbacks of the previously proposed systems.

The invention is based on exploiting the thermodynamic properties of phase-change materials (PCMs), mainly their ability to store and release thermal energy at constant temperature. This property makes it possible to envisage controlling the wall temperatures of the PCMs very precisely, to ensure greater temperature uniformity within the cells and the battery module. The heat absorption also allows greater autonomy by avoiding the need for costly, energy-intensive active systems.

The development of this innovative system is based on stratified heat storage units.

The invention allows thermal management that is targeted per hot zone, adapted both to the individual thermal behavior of the cells and to their collective thermal behavior. It is based on the installation of an original thermally activated composite that can be coupled to a smart microfluidic regeneration system.

Advantageously, the proposed system is coupled to a microfluidic thermal control circuit, based on a heat transfer liquid. For example, each PCM stratum (layer) could have a circuit that is independent of the other circuits. The same heat transfer fluid circulates in each circuit, with a controlled temperature and an exchange coefficient (h) adapted to the power to be dissipated. To achieve this, the optimized cooling circuit is connected to a smart thermal control system, to ensure the regeneration of the PCMs in each layer according to the thermal cycles. This solution ensures that the temperature of the cells (batteries) is homogenized, and can mitigate conditions that could lead to a battery thermal runaway event.

To these ends, according to a first aspect, the invention proposes a battery comprising one or more electrochemical cells and composites based on one or more solid-liquid or solid-solid PCMs configured to form a thermal management system for maintaining the temperature of one or more electrochemical cells in operation at a value lower than a given temperature, said composites being thermally conductive and comprising a heat-conductive material with a leak-tight structure that allows the PCM to be encapsulated when the PCM is a solid-liquid PCM, the battery comprising a plurality of modules each having a given composite which is leak-tight when the PCM is a solid-liquid PCM, the modules having two possible configurations, optionally combined with one another.

Encapsulation means that the PCMs are accommodated in the composite modules in a leak-tight manner, when the PCM is a solid-liquid PCM. Single-layer or multilayer micro-encapsulation can be used. Multilayer micro-encapsulation can be accompanied by a “self-healing” effect in the event of cracking due to thermal or mechanical stresses.

Advantageously, the PCMs are encapsulated in a leak-tight manner, allowing the PCMs to be kept inside the structure during their phase change without any leakage or loss of PCM.

Advantageously, the encapsulation of the PCMs allows PCM thermal conduction, in order to facilitate heat transfer.

Advantageously, the encapsulation is designed as a module with openings through which the cells can pass. This design allows the encapsulated PCMs to be placed as close as possible to the cells, and to be arranged according to their thermal and mechanical characteristics. By virtue of this specific arrangement of the PCMs according to their capabilities, it is possible to obtain the desired temperatures during cell operation, to control mechanical behavior, particularly in the vicinity of the cells, and to avoid possible liquid leaks.

In a first configuration, called the individual configuration, each individual module has an opening allowing each individual module to surround part of an electrochemical cell inserted into the opening, an electrochemical cell being surrounded along its height by a plurality of individual modules stacked one top of one another, with at least two modules having different composites, this individual configuration being implemented for just one or a plurality of cells.

In a second configuration, called the collective configuration, each collective module has a plurality of openings allowing each collective module to surround part of a plurality of electrochemical cells inserted into the openings, in two arrangements.

Advantageously, the battery has air and/or liquid micro-exchangers which comprise conductive plates and air and/or liquid microcircuits in the conductive plates, allowing compartmentalization of the modules and regeneration of the PCMs, the micro-exchangers being configured to provide a thermal conduction bridge between the PCMs.

Advantageously, the battery has air and/or liquid micro-exchangers along vertical and horizontal plates, in particular on the end plates outside the battery, in order to carry heat out of the battery.

Advantageously, these plates are aligned with and/or perpendicular to the electrochemical cells and in contact with one another, in order to carry heat out of the battery.

Advantageously, the battery has air and/or liquid micro-exchangers along plates that are parallel along the length of the PCM modules and/or perpendicular to one another, the plates being in contact with one another in order to carry the heat extracted by the PCMs out of the battery, in particular advantageously with inner plates located between the PCM modules in order to compartmentalize them and which are in contact with perpendicular plates located outside the PCM modules.

Advantageously, the exchangers are hybrid exchangers and comprise conductive plates with phase-change materials and microchannels within their thickness.

Advantageously, the plates are equipped with a system that controls the direction of flow, with valves to control the flow rates, and the plates can have the same or a different coefficient of performance (KPI).

Advantageously, the plates are equipped with two air/liquid flow circuits or first-liquid/second-liquid flow circuits.

In a first arrangement, the cells are surrounded over their height by a plurality of horizontal collective modules stacked one top of one another, with at least two modules having different composites.

In a second arrangement, cells N are surrounded over their entire height by a single Nth vertical collective module composed of a composite N, and cells N+1 adjacent to the cells N are surrounded by a single Nth+1 vertical collective module composed of a composite N+1 that is different from the composite N.

When a solid-liquid phase-change material is used, what is meant here by a leak-tight composite is a composite material comprising a solid-liquid PCM from which the PCM in its liquid state substantially cannot escape.

For example, the composite material has very low porosity, in particular very low interconnected porosity.

In some implementations, the PCM is encapsulated in the composite material, in particular micro-encapsulated in the composite material.

In other, optionally combined, embodiments, the composite material is encased in an advantageously leak-tight wall, for example made of a metal alloy.

According to various implementations, when the phase-change material is a solid-liquid phase-change material, the leak-tight composites are selected from among a composite A, a composite B or a composite C.

The composite A comprises a heat-conducting foam with at least one PCM, the foam being advantageously encased in a leak-tight layer or in a composite B or in a composite C.

The composite B comprises a matrix with at least one polymer having heat-conducting fillers and at least one PCM.

The composite C comprises a matrix with at least one polymer having at least one PCM micro-encapsulated by a heat-conducting material, and which allows the PCM to be contained during its state change.

Advantageously, the battery comprises one or more compartments for accommodating and fitting to the shape of the modules and electrochemical cells, with outer walls which fit to the outer periphery of the modules, and inner walls, the dimensions of which are configured to be in contact, on one face, with each inner wall of the openings of the modules and, on another face, with the outer periphery of the electrochemical cells.

Advantageously, the battery has air and/or liquid micro-exchangers, which allow the modules to be compartmentalized and the PCMs to be regenerated (solidified). The micro-exchangers are advantageously configured to provide a thermal conduction bridge between the PCMs.

In some implementations, the micro-exchangers comprise plates that form at least one of the walls of the one or more different compartments.

In some particular implementations, the shape of the plates is configured to allow them to be positioned perpendicular to the height of the electrochemical cells in the one or more compartments, without obstructing the openings of the modules.

In some particular implementations, the shape of the plates is configured to allow them to be positioned parallel to the height of the electrochemical cells in the one or more compartments, between adjacent electrochemical cells.

Advantageously, the composites surrounding the electrochemical cells located at the center of the battery are configured to have a latent heat greater than the latent heat of the composites located at the edges of the battery.

Alternatively or in combination, the composites surrounding the electrochemical cells located at the center of the battery comprise heat-conducting materials having a heat-conducting capacity greater than the heat-conducting capacity of the heat-conducting materials of the composites located at the edges of the battery.

Advantageously, the electrochemical cells are distributed in groups of adjacent electrochemical cells, and, for at least one group of adjacent electrochemical cells, at least two different horizontal collective modules surround all of the adjacent electrochemical cells of this group along their height.

The horizontal collective modules are selected for each group of adjacent electrochemical cells according to the following possibilities:
collective module comprising a composite A and collective module comprising a composite B; or
collective module comprising a composite A and collective module comprising a composite C; or
collective modules comprising a composite B, with variations in composition over the polymer matrices and/or conductive fillers and/or the different PCMs; or
collective modules comprising a composite C, with variations in composition over the polymer matrices and/or different micro-encapsulated PCMs and/or a different heat-conducting micro-encapsulation material.

Advantageously, the air/liquid micro-exchangers have plates and air/liquid microcircuits in the plates, these plates having openings for the electrochemical cells to pass through.

In some implementations, the battery has three horizontal collective modules, with at least two different composites for the three horizontal collective modules.

In some implementations, the electrochemical cells are distributed in groups of electrochemical cells, each group of electrochemical cells having the same vertical collective module over the entire height of the group, which is different from a vertical collective module of at least one other group of electrochemical cells over the entire height of said group. The vertical collective modules are selected according to the following possibilities:
collective module comprising a composite A and collective module comprising a composite B; or
collective module comprising a composite A and collective module comprising a composite C; or
collective modules comprising a composite B, with variations in composition over the polymer matrices and/or conductive fillers and/or the different PCMs; or
collective modules comprising a composite C, with variations in composition over the polymer matrices and/or different micro-encapsulated PCMs and/or a different heat-conducting micro-encapsulation material.

Advantageously, the battery has different individual modules stacked on top of one another and/or different collective modules, in order to create horizontal and vertical compartments around the electrochemical cells.

In some implementations, the battery comprises a plurality of electrochemical cells, each cell being individually surrounded over its entire height by an individual module comprising a composite A, a composite B or a composite C with PCM, the composites being selected for each cell according to its location relative to the other electrochemical cells in the battery.

Advantageously, the microcircuits differ per module surrounding the electrochemical cells and/or according to the location of one or more electrochemical cells in the module.

Advantageously, alongside a group of electrochemical cells surrounded by composite, there is at least one group of electrochemical cells without composite.

Advantageously, a conductive plate is located at the end part of the electrochemical cells.

The heat-conducting foams are advantageously selected from the following list: aluminum foam, copper foam, nickel foam, graphite-based foam, all heat-conducting foams.

The conductive fillers or conductive materials encapsulating the PCMs are advantageously selected from the following list: fins, expanded graphite, heat-conducting fillers originating from aluminum recycling, copper, aluminum nitride, nano-silica.

The polymers are advantageously selected from the following list: HDPE (high-density polyethylene), LDPE (low-density polyethylene), SEBS (polystyrene-b-poly(ethylene-butylene)-b-polystyrene), SEPS (poly(styrene ethylene propylene styrene)) or SEP (poly(styrene-b-ethylene-co-propylene)), PU (polyurethane), PEG (polyethylene glycol), PP (polypropylene), POE (polyethylene octene co-elastomers), SBS (styrene butadiene styrene), EPDM (ethylene propylene diene monomer), recycled polymers, biopolymers (e.g. lignocellulose polymers, chitosans, silicates, clay, etc.)

Polymers can be combined to form composites, fulfilling several functions:
encapsulating the PCM “shape-stabilized phase-change materials (SSPCMs)” e.g. Karkri et al. Polymer Testing 46 (2015), Thermochimica Acta 614 (2015) 218-225, Energy Conversion and Management Volume 77, January 2014, Pages 586-596.
increasing the “PCM stabilized shape” rate.
increasing rigidity/flexibility (Karkri et al. Applied Thermal Engineering Volume 171, 5 May 2020, 115072).

The PCMs are advantageously selected from the following list: RT paraffins, hydrated salt, hexadecane, BioPCM®, PureTemp®.

The solid-solid PCM can be selected from the following list: PEG4000, PEG6000, PEG8000, PU-SSPCM (PEG/4′ 4-diphenylmethane diisocyanate (MDI)), polystyrene-g-PEG6000, sorbitol/dipentaerythritol/inositol/PEG.

Advantageously, the composites are selected so that the temperature of the electrochemical cells during operation is lower than a given temperature, for example 40° C.

In some implementations, the walls of the one or more compartments comprise different materials or a heat-conducting composite.

According to a second aspect, the invention proposes a battery comprising one or more electrochemical cells and composites based on one or more solid-liquid PCMs configured to form a thermal management system for maintaining the temperature of one or more electrochemical cells in operation at a value lower than a given temperature, these composites being selected, when the phase-change material is solid-liquid phase-change material, from among a composite A, a composite B, and a composite C, a composite A comprising a heat-conducting foam with at least one PCM, advantageously encased in a leak-tight layer or in a composite B or in a composite C, a composite B comprising a matrix with at least one polymer having heat-conducting fillers and at least one PCM, a composite C comprising a matrix with at least one polymer having at least one PCM micro-encapsulated by a heat-conducting material.

Advantageously, the one or more electrochemical cells are surrounded by a composite A block which completely surrounds and encases the one or more electrochemical cells, the composite A block being completely surrounded and encased in the composite B or by the composite C or by a heat-conducting material such as an aluminum alloy, the composite A potentially being reinforced with heat-conducting fillers.

Advantageously, composite B or C comprises a plurality of polymers.

Advantageously, composite B or C comprises a blend of polymers from the following list: SEBS and POE; or SBS and EPDM; or HDPE and SBS.

In a second arrangement, composite B or C has a blend of polymers selected from the following list: SEBS, SEPS, SEP, PU, PEG, PP, LDPE, HDPE.

According to a third aspect, the invention proposes a system using a battery as presented above, the electrochemical cells advantageously being lithium-ion, lithium-manganese-cobalt (NMC), lithium-polymer (LiPo), lithium-iron-phosphate (LFP), lithium-cobalt-nickel-aluminum (NCA), lithium-manganese (LMO), lithium-titanate (LTO), lithium-air, lithium-cobalt-oxide (LCO), lithium-sulfur (Li—S), lithium-metal-polymer (LMP), lithium-air, or lithium-cobalt-oxide (LCO) cells, or a sodium-ion battery (Na-ion), nickel-cadmium battery (Ni—Cd), or nickel-metal hydride battery (Ni-MH).

Further objects and advantages of the invention will become apparent from the description of an embodiment, which is provided hereinafter with reference to the accompanying drawings, in which:

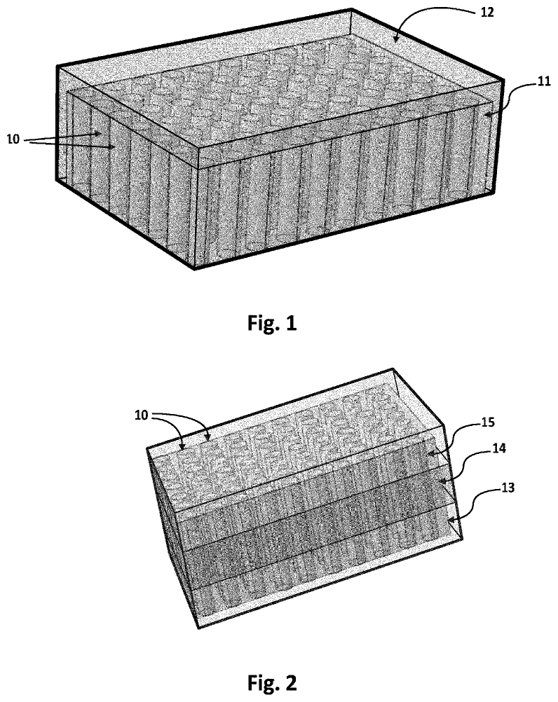

FIG. 1 is a schematic depiction of a set of cells placed in a containing matrix, encased in a diffusing matrix, according to one implementation,

FIG. 2 is a schematic depiction of a set of cells placed in a containing matrix, encased in a stratified diffusing matrix, according to one implementation,

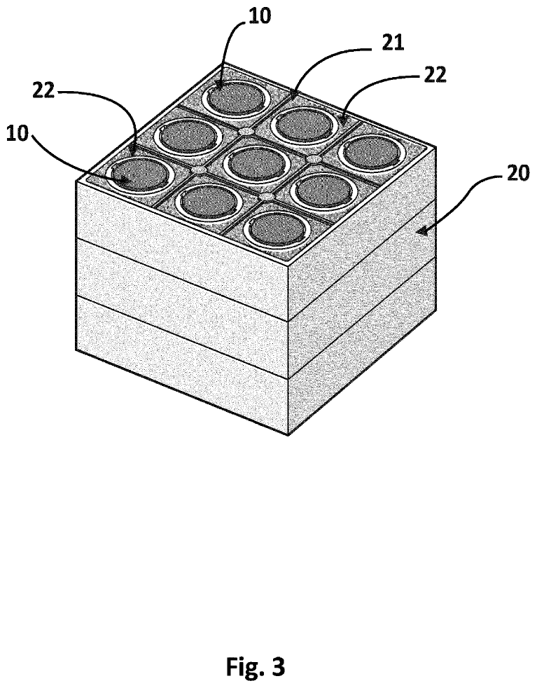

FIG. 3 is a schematic depiction of a block of cells comprising cooling plates,

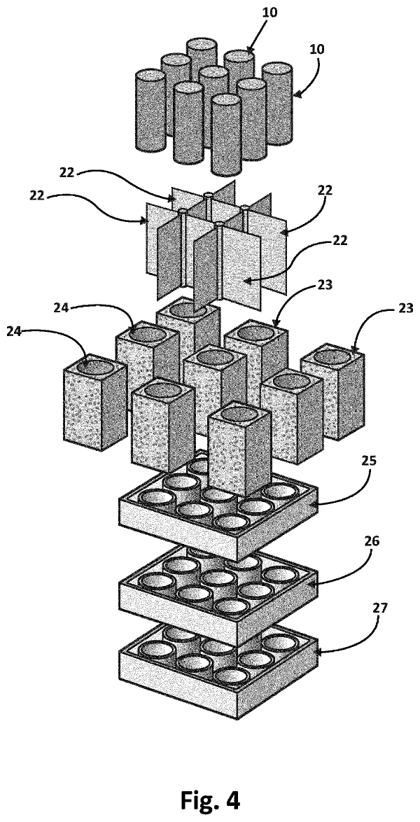

FIG. 4 is an exploded view of one embodiment of a block of cells according to FIG. 3,

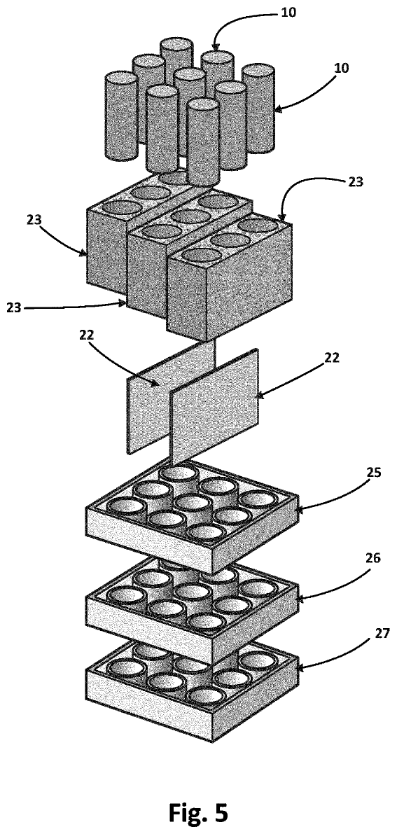

FIG. 5 is an exploded view of one alternative embodiment of a block of cells,

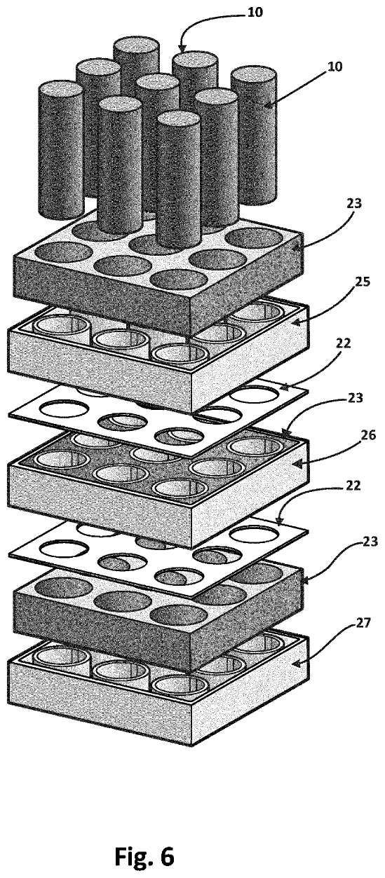

FIG. 6 is an exploded view of another alternative embodiment of a block of cells,

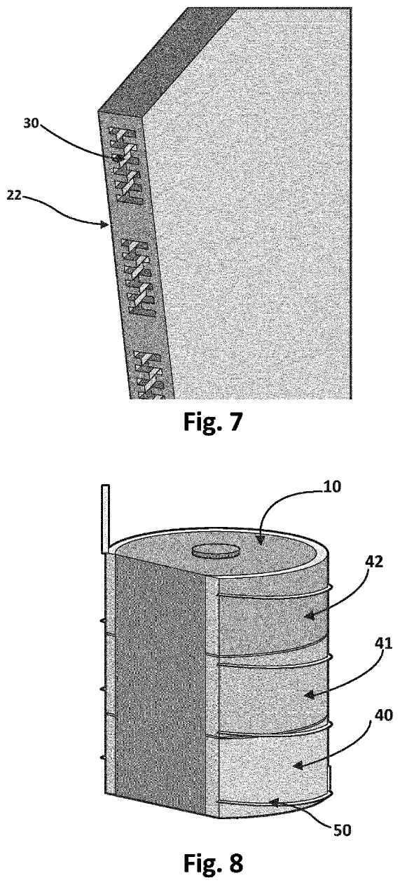

FIG. 7 is a detail view of a cooling panel that can be used in the blocks shown in FIGS. 3 to 6,

FIG. 8 is a schematic view of thermal control for a cell,

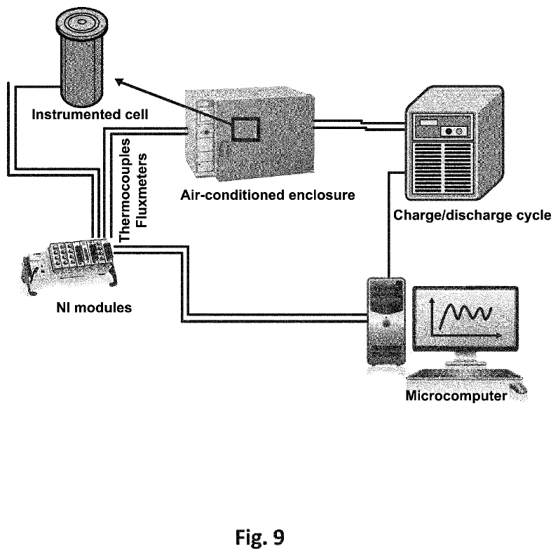

FIG. 9 is a diagram of an experimental measurement device,

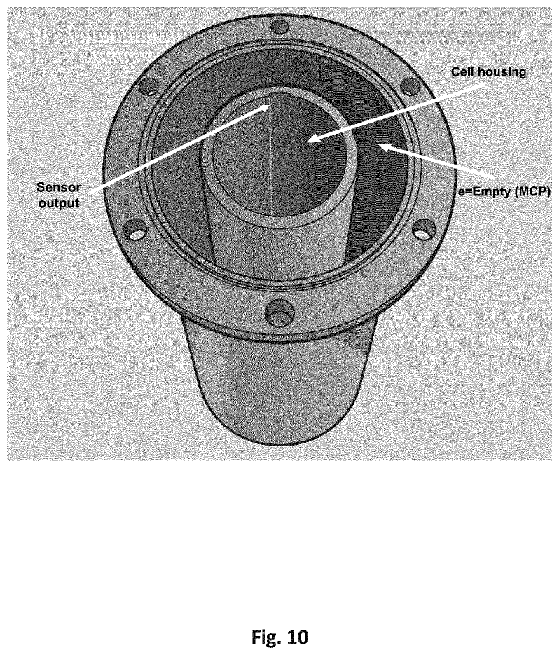

FIG. 10 is a view of a cell holder tube,

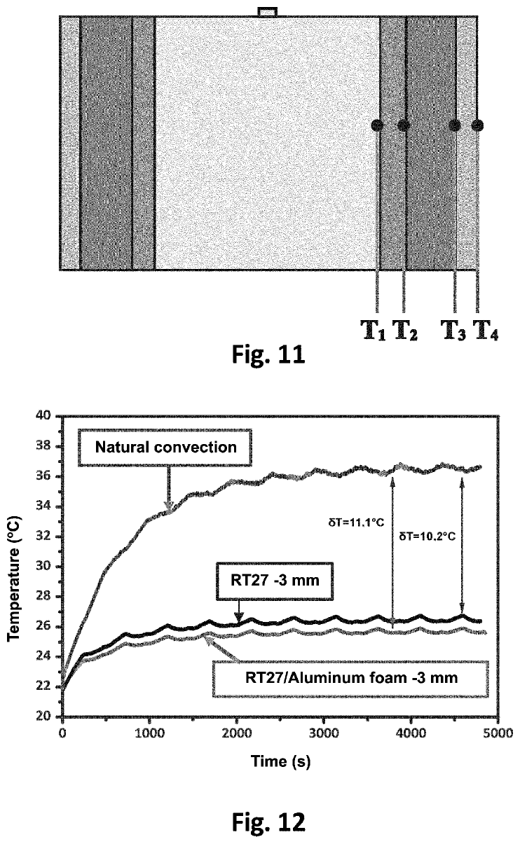

FIG. 11 is a diagram showing the installation of thermocouples in the cell holder tube of FIG. 10,

FIG. 12 is a view illustrating the variations in temperature over time without the use of PCM and with the use of PCM RT27, RT27/aluminum foam,

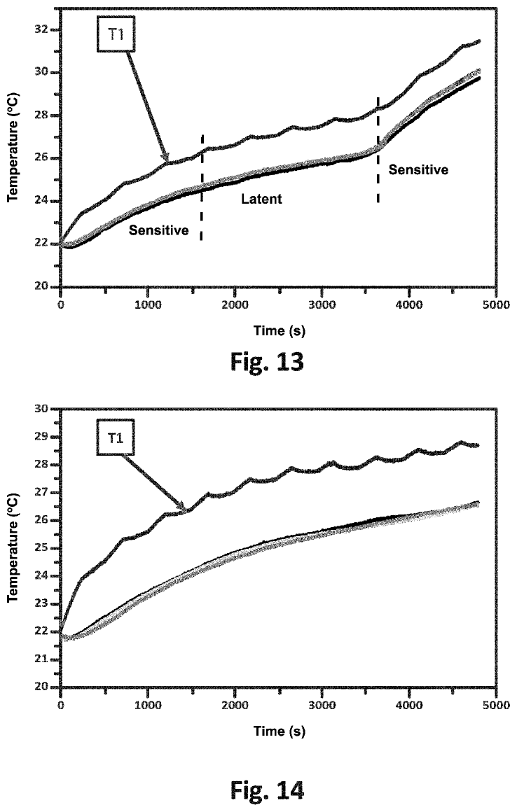

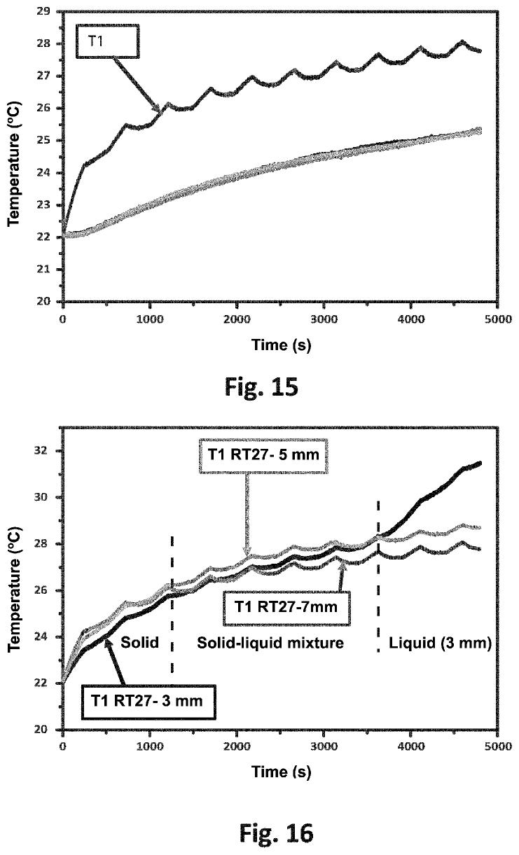

FIGS. 13, 14 and 15 show, respectively, the change in the temperature measured by the four thermocouples T1, T2, T3, T4 in the case of thermal management with pure paraffin RT27, for mold thicknesses of e=3 mm, e=5 mm and e=7 mm, respectively,

FIG. 16 depicts changes in cell temperature over time without forced convection, using pure paraffin RT27, for the three PCM thicknesses in question (3 mm, 5 mm, 7 mm),

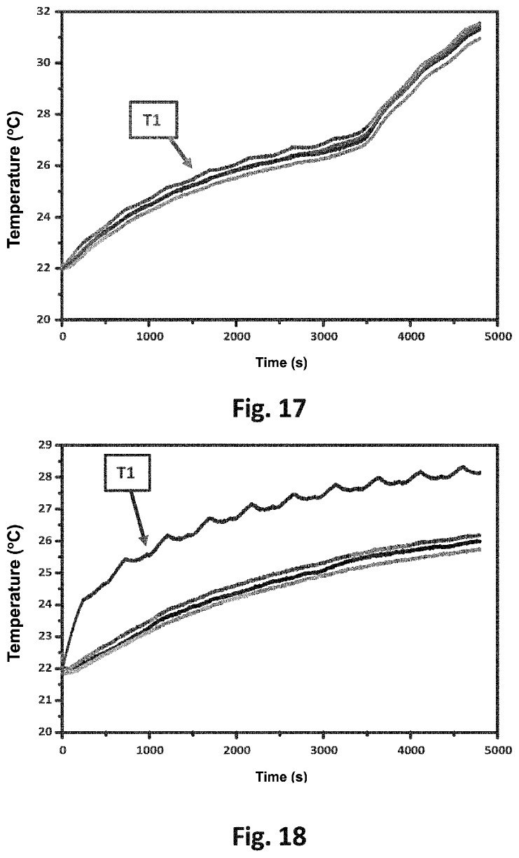

FIG. 17 depicts changes in cell temperature over time without forced convection, using pure paraffin RT27, for a thickness of 3 mm,

FIG. 18 depicts changes in cell temperature over time without forced convection, using pure paraffin RT27 and aluminum foam, for a thickness of 7 mm,

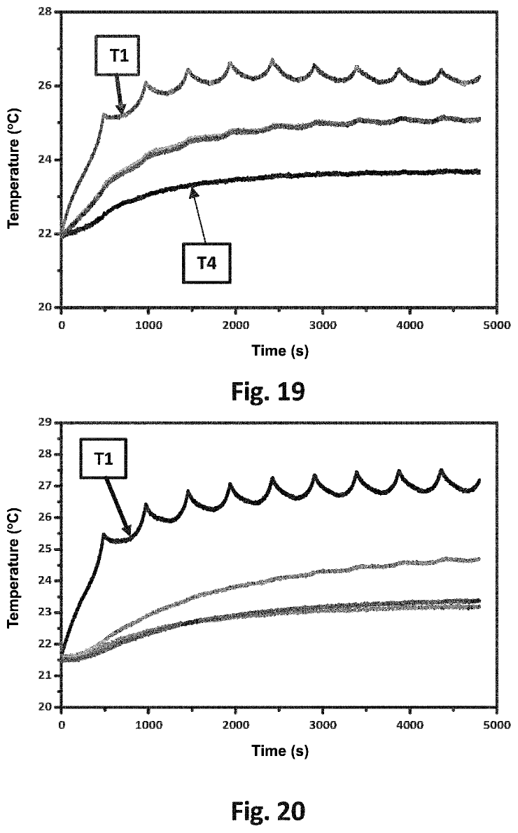

FIGS. 19 and 20 show, respectively, the change with time in recorded temperature (T1, T2, T3, T4) for pure paraffin RT27 with a thickness e of 3 mm (FIG. 19) and a thickness e of 7 mm (FIG. 20),

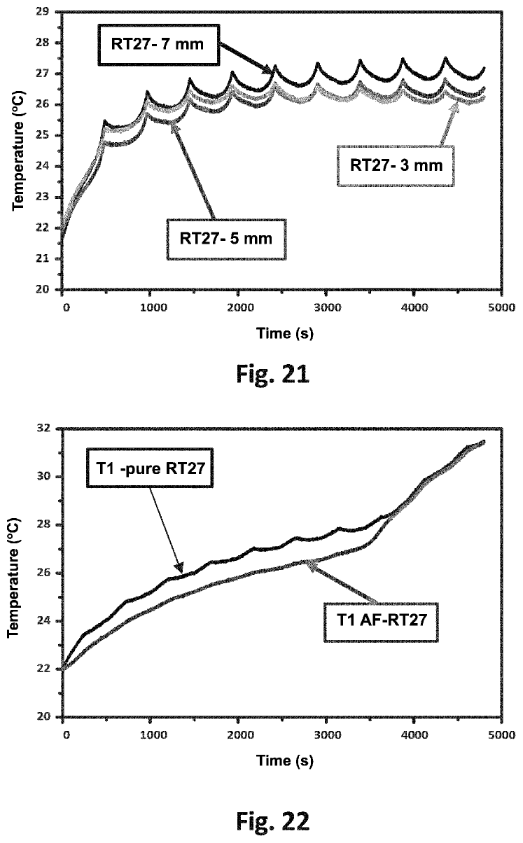

FIG. 21 shows the change with time in the temperature of the surface of the cell measured by the thermocouple T1 for the different thicknesses being studied,

FIG. 22 illustrates the effect of the metal foam on the thermal state of the cell for a thickness of 3 mm, without and with forced convection, the measurements of the temperature T1 being shown in FIG. 22 without forced convection,

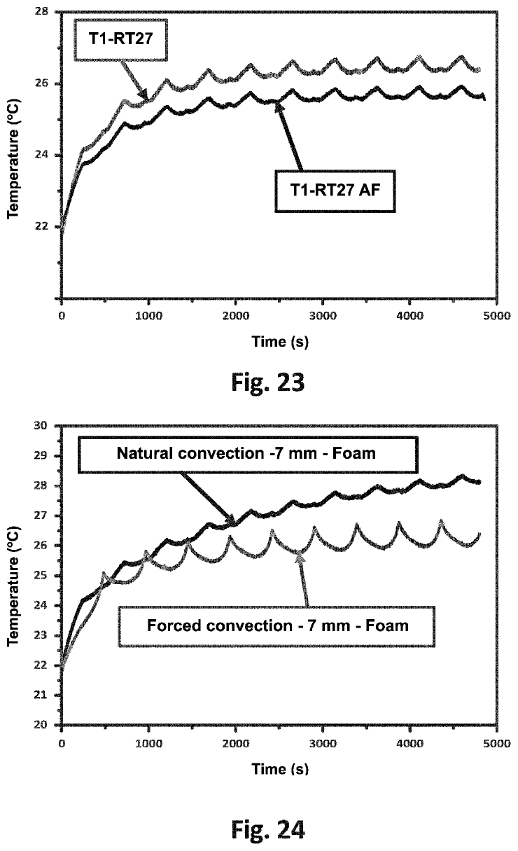

FIG. 23 shows the changes in the temperature of the cell with pure paraffin RT27 and with an AF-RT27 composite with forced convection,

FIG. 24 shows the change with time in the temperature of the cell without and with forced convection in the case of an AF-RT27 composite, e=7 mm,

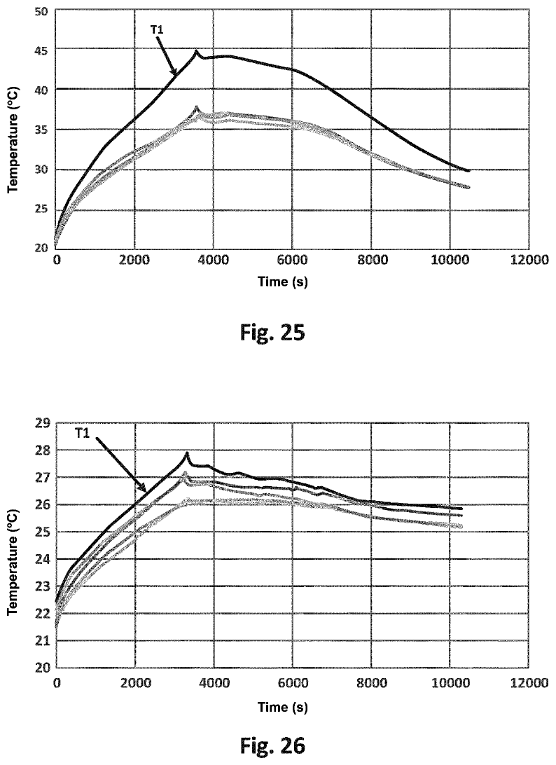

FIG. 25 shows the variation in the temperature and in the heat flux of the cells when the module operates without a thermal management system (without PCM),

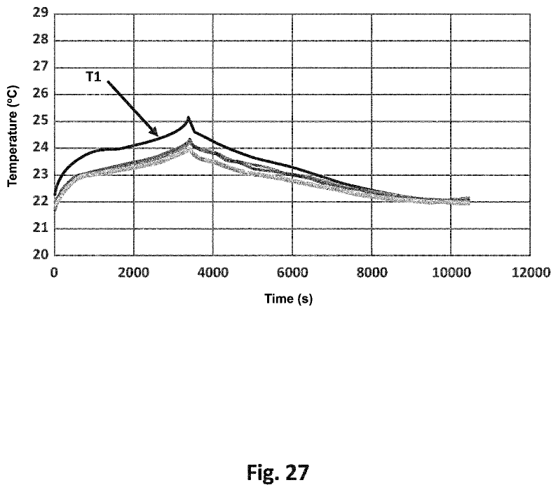

FIGS. 26 and 27 are depictions similar to FIG. 25, with the system being used without air convection or with air convection.

### GENERAL DESCRIPTION

According to a first aspect, the invention proposes a battery comprising one or more electrochemical cells and composites based on solid-liquid or solid-solid PCMs configured to form a thermal management system for maintaining the temperature of one or more electrochemical cells in operation at a value lower than a given temperature, said composites being thermally conductive when the phase-change material is a solid-liquid phase-change material, and comprising a heat-conductive material with a structure that allows the PCM to be encapsulated when the phase-change material is a solid-liquid phase-change material, the battery comprising a plurality of modules each having a given composite, the modules having two possible configurations, optionally combined with one another.

According to a second aspect, the invention proposes a battery comprising one or more electrochemical cells and composites based on solid-liquid or solid-solid PCMs configured to form a thermal management system for maintaining the temperature of one or more electrochemical cells in operation at a value lower than a given temperature, these composites being selected, when the phase-change material is solid-liquid phase-change material, from among a composite A, a composite B, and a composite C, a composite A comprising a heat-conducting foam with at least one PCM, advantageously encased in a leak-tight layer or in a composite B or in a composite C, a composite B comprising a matrix with at least one polymer having heat-conducting fillers and at least one PCM, a composite C comprising a matrix with at least one polymer having at least one PCM micro-encapsulated by a heat-conducting material.

Advantageously, the thermal management system is a stratified energy absorber for battery cooling.

Advantageously, the thermal management system is a generic thermal control system in the form of a “3D cooling plate”.

Advantageously, the thermal management system is a PCM hybrid cooling system with a regeneration liquid, allowing battery life to be significantly improved.

Advantageously, the stratified absorber also relates to thermal battery management systems used in urban e-mobility, such as bicycles, scooters and motorcycles.

Advantageously, the thermal conductivity and heat storage capacity of this system can be modified according to the heat sources to be controlled. This thermal management system also offers flexibility in shaping (horizontal and/or vertical stratification), in the choice of PCM and in the quantity of conductive fillers to be used.

### DETAILED DESCRIPTION OF THE INVENTION

In the following description, three types of composite materials are advantageously used, composite materials being referred to as composite A, composite B and composite C.

When the phase-change material is a solid-liquid phase-change material, a composite A comprises a heat-conducting foam, for example a metal foam, containing at least one phase-change material (PCM) and a leak-tight material. The metal foam is, for example, an aluminum foam, copper foam or nickel foam, graphite-based foams, all heat-conducting foams.

When the phase-change material is a solid-liquid phase-change material, a composite B comprises a polymer matrix with one or more polymers and at least one phase-change material (PCM), the matrix advantageously comprising heat-conducting fillers.

A composite C comprises a polymer matrix with one or more polymers and at least one encapsulated phase-change material (PCM), advantageously encapsulated in a heat-conducting material, the PCM being advantageously micro-encapsulated.

Advantageously, the micro-encapsulation of the three composites is a single-layer or multilayer encapsulation.

Advantageously, the multilayer micro-encapsulation is accompanied by a “self-healing” effect, in the event of cracking due to thermal or mechanical stress, for example.

Advantageously, the multilayer micro-encapsulation is accompanied by a “flame retardant” effect, in the event of thermal runaway, such as a fire.

### Composite A

A composite A is obtained, for example, via vacuum impregnation using the following method.

A solid-state PCM and a metal foam are cascaded into a Pyrex glass mold, before being put in an oven.

The oven is then evacuated, while keeping the PCM in the solid state. The vacuum makes it possible to remove the air contained in the pores in the metal foam.

The oven is then heated for 140 min to a temperature above the melting temperature of the PCM, in order to ensure that the metal foam is immersed in the liquid PCM.

The pressure in the oven is then increased, for example from 0.6 mbar to atmospheric pressure.

When the oven is at atmospheric pressure, the mold is removed from the oven and cooled, for example in a climate chamber at a fixed temperature.

Once the PCM has completely solidified, the product is removed from the mold.

The PCM impregnation process is assessed by calculating the degree of impregnation, which is advantageously close to 100%.

Tables 1, 2 and 3 show the degrees of impregnation a of the composites studied. These results demonstrate the success of the vacuum impregnation procedure.

TABLE 1
Degree of impregnation of metal foam/RT21 composites

| | ε (%) | dₚ (mm) | α (%) |
|---|---|---|---|
| Al/RT21 | 93 | 0.55 | 98.55 (0.64) |
| Ni/RT21 | 95.2 | 0.9 | 97.39 (0.76) |
| Ni/RT21 | 95 | 2.3 | 97.53 (0.77) |

TABLE 2
Degree of impregnation of metal foam/RT27 composites

| | ε (%) | dₚ (mm) | α (%) |
|---|---|---|---|
| Al/RT27 | 93 | 0.55 | 98.18 (0.65) |
| Ni/RT27 | 95.2 | 0.9 | 98.16 (0.73) |
| Ni/RT27 | 95 | 2.3 | 98.65 (0.75) |

TABLE 3
Degree of impregnation of metal foam/RT35HC composites

| | ε (%) | dₚ (mm) | α (%) |
|---|---|---|---|
| Al/RT35HC | 93 | 0.55 | 97.76 (0.72) |
| Ni/RT35HC | 95.2 | 0.9 | 97.28 (0.75) |
| Ni/RT35HC | 95 | 2.3 | 97.87 (0.74) |

### Composite B

A composite B is, for example, obtained as follows.

First, an PCM is dissolved in a solvent at 80° C., then SEBS (polystyrene-b-poly(ethylene-butylene)-b-polystyrene) and LDPE (low-density polyethylene) are added to the solution, until the mixture is uniform. The PCM is a paraffin, in particular paraffin RT42.

Expanded graphite is then gradually added.

Sonication is applied, for example for 30 min at 100 W, to break down graphite aggregates and ensure uniform dispersion of the conductive fillers in the mixture.

To evaporate the solvent, the resulting mixture is left under a fume hood at a temperature of around 120° C.

The composite is then dried in an oven, for example overnight at 130° C.

Finally, the mixture is hot-pressed, for example at 130° C. for 10 min, in a steel mold using a thermal press.

Table 4 shows an example of the mixture.

TABLE 4
Composition of SEBS/Hexadecane/LDPE/GE composites.

| | SEBS | Hexadecane | LDPE | GE | Thickness | Mass |
|---|---|---|---|---|---|---|
| | (%) | (%) | (%) | (%) | (mm) | (g) |
| S1 | 15 | 75 | 5 | 5 | 6.01 | 8.669 |
| S2 | 10 | 75 | 5 | 10 | 5.94 | 9.006 |
| S3 | 5 | 75 | 5 | 15 | 6.08 | 9.593 |
| S4 | 15 | 45 | 35 | 5 | 5.82 | 8.928 |
| S5 | 15 | 45 | 30 | 10 | 6.08 | 9.392 |
| S6 | 15 | 45 | 20 | 20 | 6.12 | 9.628 |

### Composite C

A composite C is, for example, obtained by dispersion as follows.

A known quantity of polymer (e.g.: SEBS/LDPE) is dispersed in a solvent loaded with heat-conducting PCM microcapsules.

The microcapsules are, for example, made of polymer material of natural, semisynthetic or synthetic origin.

Micro-encapsulation is achieved, for example, via interfacial polymerization or spray drying. The spray drying process involves the formation of a solution, suspension or emulsion containing a polymer and the PCM, an aerosol being formed by spraying through a pneumatic, ultrasonic or rotary nozzle. During spraying, solid microcapsules are formed after evaporation in a drying chamber, using a stream of air or nitrogen.

A vessel containing the solvent and PCM microcapsules is placed on a hot plate. Heating under reflux is used to heat the reaction mixture. Reflux prevents loss of reagent or product through evaporation.

The microcapsules are gradually incorporated into the polymers, via magnetic stirring. Stirring is maintained, for example for around 60 min under reflux, to ensure that the microcapsules-PCM are well dispersed in the LDPE/SEBS.

Additional SEBS is added while stirring, e.g. for 30 min.

As the temperature rises, some chemical species evaporate. These chemical species then rise in a water cooler. Cold water flows continuously through this cooler; on contact with the walls, the gases cool and liquefy in the form of droplets on the walls of the cooler, eventually falling back into the vessel. To evaporate the solvent, the resulting mixture is left under a fume hood at a temperature of around 120° C.

The composite is then placed in an oven, for example overnight at 120° C.

For shaping, the mixture is hot-pressed, for example at 130° C. for 10 min, in a steel mold using a thermal press.

Table 5 shows an example of the PCM-microcapsule mixture.

TABLE 5
Composition of SEBS/PCM/LDPE composites

| | SEBS/LDPE | PCM | SEBS add |
|---|---|---|---|
| | (%) | (%) | (%) |
| S1 | 65 | 30 | 5 |
| S2 | 55 | 40 | 5 |
| S3 | 45 | 50 | 5 |

### Possible Embodiments

FIG. 1 illustrates an arrangement of the composites according to a first implementation.

FIG. 1 schematically shows electrochemical cells 10, which are cylindrical in shape. These cells are, for example, 18650 cells, with a diameter of 18 mm and a length of 65 mm, or 26650 cells, with a diameter of 26 mm, or 2170 cells.

In FIG. 1, a group of seventy cells is depicted schematically, with the electrical connections omitted for simplicity.

The number of cells depends in particular on the intended use of the battery (e.g. two-wheel vehicle, car, truck). For example, forty-six cells can be connected in parallel to form a group of cells, the battery comprising two modules, each module comprising around twenty groups of cells, the modules and the groups being connected in series.

The cells are Li-ion cells, for example.

In the embodiment shown, the cells 10 are substantially equidistant and arranged in a square mesh.

In the embodiment shown, the spaces present between the cells 10 are occupied by a composite A over virtually the entire height of the cells.

Advantageously, the composite A completely surrounds all of the cells 10.

In one implementation, the composite A contains heat-conducting fillers.

The composite A block 11 containing the cells 10 is contained in a shell 12 formed by a mass of composite B or a mass of composite C, or by a heat-conducting material such as an aluminum alloy.

Advantageously, the shell 12 completely surrounds the composite A.

The shell 12 forms a container, limiting the risk of leakage of the liquid-phase PCM contained in the composite A.

The shell 12 is heat conductive and promotes regeneration (solidification) of the PCM contained in the composite A.

FIG. 2 depicts one alternative embodiment. In this alternative, the group of cells 10 is, for example, that described with reference to FIG. 1, and this group of cells 10 is contained in a stratified shell, comprising a first layer 13, a second layer 14 and a third layer 15 of composite material.

Each of the three layers 13, 14, 15 can be formed by a mass of composite A, a mass of composite B or a mass of composite C.

In one implementation, one layer, for example the second layer 14, is formed by a composite A, the other two layers being formed by two masses of composite B, these two layers of composite B comprising different polymer matrices and/or different conductive fillers and/or different PCMs.

In another implementation, one layer, for example the second layer 14, is formed by a composite A, the other two layers being formed by two masses of composite C, these two layers of composite C comprising different polymer matrices and/or different micro-encapsulated PCMs, and/or a different micro-encapsulation material.

In the embodiment depicted, the three layers 13, 14, 15 are substantially planar and of equal thickness, and extend substantially perpendicular to the axis of elongation of the cells 10.

Advantageously, the number of layers is greater than 2. Advantageously, the number of layers is adapted to the thermal state of the cell.

In other embodiments, the three layers 13, 14, 15 have thicknesses that differ from one another. For example, the intermediate layer 14 is thicker than the lower layer 13 and the upper layer 15.

In other embodiments, the three layers 13, 14, 15 extend substantially parallel to the axis of elongation of the cells 10. For example, a layer 14 advantageously surrounds the cells in the center of a group of cells.

The properties of the composites used for the three layers are advantageously different. For example, one of the layers has a higher thermal conductivity than the other two layers, or a higher phase-change temperature for the PCM.

In other embodiments, the shell contains two layers or more than three layers. The arrangement of different layers of composites in the shell forms a stratified arrangement, each layer being able to be adapted to the thermal properties of the cells, in particular at a given height along the axis of elongation of the cells.

The stratified shell forms a container limiting the risk of leakage of the liquid-phase PCM contained in the composite A.

The stratified shell is heat conductive and promotes regeneration of the PCM contained in the composite A, taking into account a thermal gradient along the height of the cells 10.

FIG. 3 illustrates a block of cells comprising a shell 20, at least one phase-change material 21 contained in the shell 20, and cooling panels 22.

The phase-change material 21 can be a composite A, a composite B or a composite C, or a variant of one of these composites.

In the embodiment depicted in FIG. 3, the block comprises nine substantially identical cylindrical cells 10 arranged equidistantly in three columns and three rows. It is understood that the number of cells 10 in the block can be fewer than nine, or more than nine, depending on the intended applications of the battery.

In one implementation, the phase-change material 21 is identical for the entire block of cells.

In other embodiments, the phase-change material 21 is adapted to the thermal behavior of each cell 10 of the block. For example, a composite A is used for the one or more cells in the center of the block, and a composite B or composite C is used for the cells at the periphery of the block.

FIG. 4 illustrates one embodiment of the block shown in FIG. 3.

As shown in FIG. 4, a selection of multiple features makes it possible to ensure uniformity of temperature within a block of cells 10.

A first selection advantageously relates to the material of the module 23 in contact with the cells 10. As shown in FIG. 4, this material of the module 23 takes the form of a parallelepipedal block, forming an individual composite module provided with an axial hole 24, and can be selected for each cell 10. The material of module 23 comprises, for example, a composite A, a composite B or a composite C. In the embodiment depicted, the material of the module 23 extends along substantially the entire height of the cells 10. In other embodiments, the material of the module 23 is formed of at least two different materials, stacked along the height of the cells 10. The individual module 23 is thus stratified, allowing adaptation to any potential thermal gradient along the axis of elongation of the cell.

A second selection relates to the shell. This second selection is advantageously combined with the first selection. In the embodiment depicted, the shell is formed of three stacked elements, forming compartments 25, 26, 27. Each of the compartments 25, 26, 27 can be formed of a thermally conductive material, for example a metal alloy such as an aluminum alloy. In the embodiment depicted in FIG. 4, the three compartments 25, 26, 27 are substantially identical. In other embodiments, one of the compartments is thicker than the other compartments, measured along the axis of elongation of the cells 10.

A third selection relates to the number and arrangement of cooling panels 22. This third selection is advantageously combined with the first and/or second selection.

In the embodiment depicted in FIG. 4, the block comprises four substantially identical cooling panels 22, extending along the height of the cells 10, between two rows and between two columns of adjacent cells 10.

The panels 22 are thus arranged in two groups. In each group, the panels 22 are substantially parallel to one another. The panels of a first group are substantially perpendicular to the panels of the second group.

In the alternative embodiment of FIG. 5, the block comprises two substantially identical cooling panels 22, extending along the height of the cells 10, between two rows of adjacent cells 10. In this alternative embodiment of FIG. 5, the modules 23 are collective, collectively surrounding a plurality of cells 10, and comprise, for example, three holes for three cells 10 to pass through. The cooling panels 22 extend between collective modules 23.

Advantageously, the modules 23 differ depending on the thermal state of the battery. Advantageously, the modules 23 differ per block within the battery.

Advantageously, the structure has a stratified arrangement of modules 23. For example, the stratified arrangement follows one of these combinations (from the lower layer to the upper layer, or from the upper layer to the lower layer): composite A-composite B-composite C; composite B-composite A composite C; composite A-composite C-composite B; composite B-composite B′-composite B″; composite C-composite C′-composite C″; composite A-composite B-composite B′; composite B-composite A-composite B′; composite A-composite C-composite C′; composite C-composite A-composite C′; composite C-composite B-composite B′; composite B-composite C-composite B′; composite B-composite C-composite C′; composite C-composite B-composite C′.

Advantageously, the layers of composites are composed of a mixture of at least one of the following composites: composite A; composite A′; composite A″; composite B; composite B′; composite B″; composite C; composite C′; composite C″. By way of example, a composite layer is: composite A+B; composite A+B′; composite A+B″; composite A+C; composite A+C′, composite A+C″; composite A′+B′; composite A+B+C; composite A+B′+C; composite A+B+C′; composite A+B″+C; composite A+B′+C′; composite A+B′+C″; or composite A′+B′+C′.

Advantageously, the layers of composites are different in order to ensure optimum management of the cells and allow the service life of the cells to be increased.

Advantageously, a composite X′ is different from the composite X, such that the composite X′ has a different composition from X with a similar structure. X can be A, B or C.

Advantageously, the layers of composites in the stratified arrangement have a particular shape, allowing the layers of composites to interlock. Advantageously, the particular shape is composed of “male” triangles, “female” triangles, “male” rectangles, “female” rectangles, “male” pyramids, “female” pyramids, “male” cones, “female” cones, “male” columns, “female” columns and so on. For example, a first layer of composites can have “male” triangles on a surface in contact with a layer of composites layer, while the second layer of composites has “female” triangles on the surface in contact with the first layer of composites.

Advantageously, when the phase-change material is a solid-liquid phase-change material, the layers of composites comprise at least two leak-tight polymers for the PCMs.

Advantageously, the layers of composites comprise at least three leak-tight polymers for the PCMs.

Advantageously, the layers of composites comprise at least four leak-tight polymers for the PCMs.

In the alternative embodiment of FIG. 6, the block comprises two substantially identical cooling panels 22, extending perpendicular to the axis of elongation of the cells 10, the material surrounding the cells 10 being formed by three modules 23, these three modules 23 being stacked along the axis of elongation of the cells 10. A panel 22 extends between two modules 23. Each module 23 is placed in a compartment 25, 26, 27.

FIG. 7 shows the geometry of the circulation microchannels 30 in the cooling panels 22, according to one embodiment. The microchannels 30 comprise baffles (of variable dimensions), thereby promoting heat exchange. The microchannels form heat exchange micropaths. The panels 22 allow air or a coolant to circulate.

FIG. 8 schematically shows a hybrid thermal management system for a cell 10. The cell 10 is surrounded by a sleeve formed by the stacking of at least two different composites. In the implementation depicted, three rings 40, 41, 42 are stacked along the axis of elongation of the cell, each of the rings 40, 41, 42 being able to contain a composite A, a composite B, or a composite C. A coil 50 wound in a spiral around the sleeve formed by the rings 40, 41, 42 contains a heat transfer fluid.

The panels 22 or coils 50 can be coupled to a heat-transfer-liquid-based microfluidic thermal control circuit.

Advantageously, each coil 50 or each layer of material 23 has a circuit independent of the other circuits.

In some implementations, the same heat transfer fluid circulates in each circuit, with a controlled temperature and an exchange coefficient adapted to the power to be dissipated. To achieve this, the optimized cooling circuit is connected to a smart thermal control system, to ensure the regeneration of the PCMs in each individual or collective module 23 according to the thermal cycles. These provisions ensure that the temperature of the cells 10 is homogenized, and can mitigate conditions that could lead to a battery thermal runaway event.

Advantageously, the phase-change materials are of natural origin.

Advantageously, the concentration of PCM differs from one layer of composites to another, while maintaining the same type of PCM.

Advantageously, the type of PCM differs from one layer of composites to another, while maintaining the same concentration of PCM.

Advantageously, the type of PCM and the concentration of PCM differ from one layer of composites to another.

Advantageously, at least two different types of PCM are present in the same composite layer.

Advantageously, the micro-encapsulation of the PCMs in the composite C is optimized according to the thermal state of the cell. For example, the composition of the micro-encapsulation can be of a different nature or thickness.

Advantageously, the micro-encapsulation of the PCMs in the composite C has a multilayer structure. Advantageously, each layer making up the multilayer structure has a different function.

Results obtained will be presented with reference to FIG. 9 and the following figures.

The results that will be presented relate to thermal phenomena in a Li-ion cell, and the dimensioning and optimization of a passive management system using an PCM-metal foam (MF) composite, the cell 10 advantageously being maintained at a temperature above 30° C. under a load of 1 C.

A test bench was developed to track the temperature change in a Li-ion cell 10 and its heat flux given off when under load.

The heat actually dissipated by the cell 10 was calculated using experimental results and a calculating code developed in Matlab.

The thermal behavior of the PCM and of the PCM-metal foam MF composite were simulated using COMSOL Multiphysics and Matlab.

The experimental test bench is shown in FIG. 9.

The 2500 mAh electrochemical cell 10 under study is connected to a DC power supply for charging and to an active load for discharging. The cell 10 is cylindrical, with a radius of 9.255 mm and a height of 70 mm.

Electromechanical relays are inserted, allowing the electrical circuit to be opened and closed. The surface temperature of the cell 10 is measured by two type T thermocouples. A cylindrical fluxmeter covers the cell 10, in order to measure the heat flux dissipated over time.

A LabVIEW program was developed to track the charge/discharge cycles of the batteries. It makes it possible both to control the relays, the power supply and the active load and to acquire the measured data.

The battery under study is suspended so as to avoid heat exchange through conduction between the surface of the battery and the external environment.

The cell 10 under study is placed in an aluminum mold, depicted in FIG. 10. The mold takes the form of two hollow coaxial aluminum cylinders of height h and thickness e. The two cylinders form an inner tube (containing the cell) and an outer tube.

The inner tube has the same diameter as the cell 10.

The PCM, with or without the metal foam MF, is inserted into the space between the inner tube and the outer tube.

A groove is provided at the cell-inner tube interface in order to accommodate temperature sensors and fluxmeter wires.

The sizing of the molds takes into account the expansion in the volume of the PCM. Aluminum is selected for its good compromise between thermal properties, density and cost. In order to study the effect of the mass of PCM, three molds with different thicknesses (3 mm, 5 mm and 7 mm) were produced. All of the molds were produced using metal 3D printing.

Liquid paraffin is injected into the space designed to contain it. After filling, the assembly is cooled in the climate chamber at a set temperature of 22° C.

Before inserting the cell 10 into the mold, all of the connections must be protected in order to prevent direct contact between the aluminum mold and the batteries.

In the case of a metal foam MF-PCM composite, the metal foam (e.g. aluminum foam AF) was cut using a laser cutting system into tubes of size h*e. The tubes are filled with paraffin according to the vacuum impregnation procedure described above.

After filling and instrumentation, the cell 10 and the mold are put in a climate chamber. The base of the mold is insulated with a layer of expanded polystyrene.

To assess the effectiveness of using paraffin RT27 and the AF-RT27 composite and their ability to absorb the heat generated by cell 10 over charge/discharge cycles, the radial temperature change was tracked at the interfaces using four type K thermocouples: T1, T2, T3 and T4, arranged as shown in FIG. 11.

The thermocouple T1 is placed between the cell 10 and the inner wall of the inner tube. The thermocouple T2 is placed between the outer wall of the inner tube and the composite. The thermocouple T3 is placed between the composite and the inner wall of the outer tube. The thermocouple T4 is placed on the outer wall of the outer tube.

### Running the Tests and Defining the Steady State

The tests were carried out for different currents and for a maximum voltage of 3.8 V, with no pause between two consecutive cycles. A cycle corresponds to charging followed by discharging. If the fully charged battery is discharged via a current of 2.5 A, it will reach its cut-off voltage after one hour of discharging. The tests are stopped once the steady state has been reached. Specifically, the temperature initially increases and then tends toward a constant value, which characterizes the steady state.

### Change in the Temperature of the Cell

FIG. 12 shows the change in the temperature measured by thermocouple T1 over time. The results are presented for a mold thickness of 3 mm. For the three cases studied, i.e. natural convection (cell without thermal management system), paraffin RT27 and the aluminum foam AF (porosity 0.93, pore density 40 PPI)-paraffin RT27 composite, the results are obtained under the same conditions, i.e. an imposed current of 1 C (2.6 A) for ten charge/discharge cycles of eight minutes.

In the case of thermal management using pure paraffin RT27 and a paraffin/aluminum foam AF composite, the temperature imposed is 22° C. In these cases, ventilation is active, to promote heat exchange between the evaporator (condenser in the case of heating) and the air inside the climate chamber.

The results show that the addition of a pure PCM or a MF-PCM composite considerably reduces the temperature of the cell 10. In the case of management with pure paraffin RT27 or AF-paraffin RT27 composite, the steady state is reached after two cycles, compared with five cycles in the case of natural convection.

In the steady state, the temperature of the cell 10 with natural convection reached 36.7° C., compared with 26.5° C. when pure paraffin RT27 is used and 25.6° C. when a paraffin RT27-aluminum foam composite (0.93, 40 PPI) is used.

Pure paraffin RT27 reduces the temperature of the cell 10 by 10.2° C. (steady state mean deviation), while the paraffin RT27-aluminum foam AF (0.93, 40 PPI) composite reduces the temperature of the cell by 11.2° C. (steady state mean deviation).

Temperature Distribution without Forced Convection

In order to avoid heat losses from the cell 10 to the ambient air, and to simulate the case where the cell 10 is placed in a very confined location (battery module), tests without forced convection were carried out. The assembly is placed in the climate chamber, initially in thermal equilibrium at 22° C., isolated from any heat exchange with the surrounding environment.

FIGS. 13, 14 and 15 show, respectively, the change in the temperature measured by the four thermocouples T1, T2, T3, T4 in the case of thermal management with pure paraffin RT27, for mold thicknesses of e=3 mm, e=5 mm and e=7 mm, respectively.

In FIGS. 13, 14 and 15, the changes in temperatures measured by the thermocouples T2, T3 and T4 are substantially identical. The temperature curve measured by the thermocouple T1 (cell temperature) is at a distance from the other three overlaid curves T2, T3, T4 (PCM temperatures).

The results show complete melting of the pure paraffin RT27 in the case of a thickness of 3 mm, which leads to high temperatures with respect to the other cases. Underestimating the amount of PCM needed to absorb the heat generated by the cell 10 can therefore lead to high temperatures.

The difference between the temperature of the cell (T1) and the paraffin (T2) is inversely proportional to thickness. The smallest difference is observed in the case of a thickness of 3 mm. Increasing the thickness of the paraffin increases thermal resistance due to its low thermal conductivity, leading to less intense heat transfer in the case of a pure solid or a pure liquid.

FIG. 16 depicts changes in the temperature of the cell 10 over time without forced convection, using pure paraffin RT27, for the three PCM thicknesses in question (3 mm, 5 mm, 7 mm).

In the solid phase, a lower temperature is observed for a thickness e of 3 mm, compared with the other two cases. In addition, after the paraffin RT27 has completely melted, there is an inflection in the curve representing the change in the temperature of the cell 10.

The change in the temperatures T1, T2, T3, T4 in the case of an MF-PCM composite without forced convection was evaluated for the thicknesses of 3 mm and 7 mm. The results are shown in FIG. 17 (3 mm thickness) and 18 (7 mm thickness). The metal foam is an aluminum foam (AF).

The results show that the addition of a metal foam MF made it possible to significantly reduce the difference in temperature between the cell 10 and the MF-PCM composite by improving the effective conductivity of the RT27/metal foam composite.

The difference between T1 and T2 remains small for an MF-PCM composite thickness of 3 mm, being around 0.5° C. (FIG. 17).

For a PCM thickness of 7 mm, the difference between the temperature T1 of the cell and the temperature T2 of the PCM is 2.5° C. in the case of pure paraffin RT27 and 1.6° C. in the case of AF-RT27 (FIG. 18). These results are in line with those obtained from numerical studies.

Temperature Distribution with Forced Convection

In order to test the effect of convection on the thermal state of the cell 10, ventilation is activated, with the aim of ensuring a uniform temperature in the climate chamber (22° C.).

FIGS. 19 and 20 show, respectively, the change with time in recorded temperature (T1, T2, T3, T4) for pure paraffin RT27 with a thickness e of 3 mm (FIG. 19) and a thickness e of 7 mm (FIG. 20).

The steady state is reached more quickly in the case of a thickness of 3 mm, with thermal homogeneity depending on thickness (T2=T3).

In both configurations studied, the paraffin is not completely melted at the end of the test. This can be attributed to heat losses through forced convection.

The effect of the quantity of PCM used is evaluated for the three thicknesses studied (e=3 mm, e=5 mm and e=7 mm) in the case of an imposed ambient temperature with ventilation (forced convection). The tests were carried out under the same conditions: 1 C current (2.6 A) for ten charge/discharge cycles of eight minutes at an ambient temperature of 22° C.

FIG. 21 shows the change with time in the temperature of the surface of the cell 10 measured by the thermocouple T1 for the different thicknesses being studied.

Increasing the thickness of the PCM has a negative impact on the thermal management of the cell 10. Specifically, the PCM has low thermal conductivity, which reduces the intensity of the heat transfer to the outside. In this case, this system should be combined with an active management system (air, heat transfer fluid).

### Effect of Adding a Metal Foam and Forced Convection

The effect of the metal foam on the thermal state of the cell 10 is evaluated for mold e=3 mm, without and with forced convection. The measurements of the temperature T1 are shown in FIG. 22, without forced convection.

In FIG. 22, it can be seen that the addition of the metal foam reduces the temperature of the cell 10 during the melting process. Specifically, the addition of a conductive foam intensifies heat transfer. In principle, a greater effect should be achieved if forced convection is prevent.

To confirm or refute this, the temperature of the cell 10 with pure paraffin RT27 was compared with that with an AF-RT27 composite (FIG. 23, with forced convection). The comparison shows a steady state temperature mean deviation of around 1.2° C. between the temperature of the cell 10 with pure RT27 and with the AF (0.93, 40 PPI)-RT27 composite.

FIG. 24 shows the change with time in the temperature of the cell 10 without and with forced convection in the case of an AF-RT27 composite, e=7 mm. With forced convection, the steady state is reached after around five cycles, while with natural convection the temperature of the cell 10 continues to rise. The temperature of the cell 10 at the end of the test with isolation reached 28.5° C., while that with convection was 26.3° C., i.e. a difference in temperature of around 2.2° C.

### Thermal Management of the Li-Ion Battery Module

In this section, the results obtained in the thermal management of a battery module composed of nine Li-ion cells 10 assembled in the 3S-3P configuration are presented.

The test procedure corresponds to one cycle of discharging then charging without pause. The battery module is first discharged at a constant current of 6 A to the minimum voltage of 8 V, and then charged using the CC-CV method at a current of 6 A to the maximum voltage of 12 V.

A total of twenty thermocouples and fifteen fluxmeters are used to evaluate the change in temperature within the module. Only five cells 10 are instrumented. Before installing the fluxmeters and thermocouples, a thin layer of thermal grease is spread over the lateral surface of the cells 10 to facilitate heat transfer to the fluxmeters and reduce contact resistance.

Next, the cells 10 are placed in the climate chamber, by means of which the temperature is fixed at 21.5° C.; the Li-ion cells are then assembled in the 3S-3P configuration while maintaining a cell-to-cell distance of 3 mm by virtue of two 3D-printed support plates.

FIG. 25 shows the variation in the temperature and in the heat flux of the cells 10 when the module operates without a thermal management system (without PCM). It can be seen that the maximum temperature of the module is over 35° C., despite a forced convection system with a constant temperature of 21° C. during charging and discharging.

### Thermal Management Using PCM+ Metal Foam

The metal foam MF/phase-change material PCM composite is introduced into the cell support mold.

The same tests as above (discharge-charge without pause) are used. The temperature is maintained at 21.5° C. with ventilation deactivated.

The experimental results show that the maximum temperature measured within the battery module is 27.8° C., with forced ventilation allowing the temperature to be reduced to 25.22° C. It can also be seen that the central cell always has the highest temperature within the module.

With regard to flux densities, there is no great difference when the system is loaded without air convection and when air convection is activated (FIGS. 26 and 27).

The invention has numerous advantages.

Advantageously, the invention provides a thermal management system for batteries, in particular Li-ion batteries, that allows battery temperatures to be maintained below 40° C.

Advantageously, the invention makes it possible to provide a thermal management system for batteries, in particular Li-ion batteries, using phase-change heat-conducting composites, that makes it possible to maintain the temperature of the battery close to the optimum operating temperature.

Advantageously, the invention makes it possible to provide a thermal management system for batteries, particularly Li-ion batteries, using metal foams, conductive fillers and paraffins, that allows the cell temperature to be maintained between 15° C. and 30° C.

Advantageously, the invention makes it possible to provide a thermal management system for a battery, in particular a Li-ion battery, that preserves battery life and ensures optimal operation for as long as possible.

Advantageously, the invention makes it possible to provide a thermal management system for a battery, in particular a Li-ion battery, that allows the temperature distribution in the battery to be made uniform.

Advantageously, the invention makes it possible to provide a thermal management system for a battery, in particular a Li-ion battery, that makes it possible to increase battery service life and preserve its state of health.

The invention thus proposes a battery provided with at least one electrochemical cell and a composite material comprising a solid-liquid phase-change material (PCM), the battery comprising a containing matrix surrounding the one or more cells, and a diffusing matrix surrounding the containing matrix, the containing matrix comprising one or more blocks of composite material, each block of composite material surrounding at least one cell over at least part of its height.

The diffusing and/or containing matrix comprises at least two layers of different composite materials.

The composite materials are advantageously selected from the group comprising:
a composite A, comprising a heat-conducting foam containing a phase-change material (PCM);
a composite B, comprising a polymer matrix and a phase-change material (PCM);
a composite C, comprising a polymer matrix and an encapsulated phase-change material (PCM).

The containing matrix surrounds the one or more cells and is thus directly subjected to temperature rises in the cells, for example during battery fast charging or intensive use of an electric vehicle. Advantageously, a conductive material is placed between the containing matrix and the cells, for example a conductive grease.

Heating of the cells leads to a phase change in the PCM used in the containing matrix.

The risk of leakage of liquid PCM is limited by the presence of the diffusing matrix, which surrounds the containing matrix. Advantageously, the diffusing matrix completely surrounds and encases the containing matrix.

Alternatively, or in combination, when the phase-change material is a solid-liquid phase-change material, the composite of the containing matrix is leak-tight. What is meant here by a leak-tight composite is a composite material comprising a solid-liquid PCM from which the PCM in its liquid state substantially cannot escape. For example, the composite material has very low porosity, in particular very low interconnected porosity. In some implementations, the PCM is encapsulated in the composite material, in particular micro-encapsulated in the composite material. In other, optionally combined, embodiments, the composite material is encased in an leak-tight wall, for example made of a metal alloy.

The presence of at least two layers in the containing and/or diffusing matrix, comprising different composite materials, makes it possible to adapt to the heterogeneous thermal behavior of the cells.

When the cells have an axis of elongation, the layers of the containing matrix and/or of the diffusing matrix extend substantially perpendicular to the axis of elongation of the cells. This arrangement makes it possible to account for a thermal gradient of the cells in their direction of elongation.

Advantageously, the PCMs contained in the layers of the diffusing and/or containing matrix have melting temperatures that differ from one another.

Advantageously, the containing and/or diffusing matrix comprises heat-conducting fillers, selected, for example, from the group comprising expanded graphite, copper and aluminum nitride.

Advantageously, the battery has air/liquid micro-exchangers that allow compartmentalization of the modules 23 and regeneration of the PCMs, the micro-exchangers being configured to provide a thermal conduction bridge between the PCMs.

Advantageously, the micro-exchangers have shapes optimized to increase the efficiency (with a KPI, “key performance indicator”) of the device.

Advantageously, the micro-exchangers have a given flow rate and circulation speed. Advantageously, the flow rate is adapted to the shape of the micro-exchangers and/or adapted to the thermal state of the cell and/or adapted to the number of cells.

Advantageously, the micro-exchangers are microchannels in the direction of stratification and/or perpendicular to the plane of stratification.

Advantageously, the liquid circulating inside the micro-exchangers is air, water or a heat transfer liquid. Advantageously, the liquid inside the micro-exchangers is changed/selected according to the operating temperature and operating constraints.

Advantageously, the system for actuating fluid circulation is based on an overall management program, with multiple program input parameters: temperature, volume expansion, etc.

An additional automated system can be associated in order to ensure forced regeneration at a programmable time and temperature. Regeneration can be targeted, per identifiable block, using a network of optimally located sensors and actuators managed by computer logic.

Advantageously, the system of the present invention is coupled to another system. Advantageously, the system of the present invention transmits thermal energy to the coupled system. Advantageously, the system of the present invention is of sufficiently large size to make use of the energy gain. In the case of electric vehicles, for example, the heat recovered is used to supplement the passenger compartment heating system.

The invention allows thermal management per battery zone, in particular for each group of cells. The invention thus allows a high degree of temperature uniformity along the height of each cell, or within a battery module. In particular, the invention makes it possible to avoid the presence of a thermal gradient between the core of a battery and its periphery.

The invention greatly reduces the risk of leakage of the PCM in the liquid phase.

The invention allows a battery, in particular a Li-ion battery, to be maintained at a substantially uniform temperature within the optimum operating range, advantageously between 15° C. and 35° C. for Li-ion batteries.

The thermal management system according to the invention takes the form of a stratified energy absorber. Such a system is particularly applicable to the case of batteries used in electric bicycles, electric scooters and electric two-wheel vehicles (scooters, motorcycles).

In one implementation, the thermal management system according to the invention is a PCM+regeneration liquid hybrid cooling system, allowing battery life to be significantly improved.

The invention is advantageously applicable to electric vehicles, particularly motor vehicles or two-wheel vehicles.

The invention is also applicable to the cooling of microprocessors, or to the conditioning of energy storage batteries in photovoltaic systems or solid hydrogen storage tanks.

Advantageously, the invention is used for batteries for energy storage systems, telecom devices, space devices, renewable energy devices, electronic devices such as power converters, data centers, electric vehicles, etc.

1. A battery comprising electrochemical cells and composites based on one or more solid-liquid or solid-solid phase-change materials (PCMs) configured to form a thermal management system for maintaining the temperature of one or more electrochemical cells in operation at a value lower than a given temperature,
wherein:
said composites comprise one or more conductive materials and a leak-tight structure that allows the PCM to be encapsulated when the PCM is a solid-liquid PCM,
the battery comprising a plurality of modules each having a given composite which is leak-tight when the PCM is a solid-liquid PCM,
the composite modules have:
an individual configuration, in which each individual module has an opening allowing each individual module to surround part of an electrochemical cell inserted into the opening, an electrochemical cell being surrounded along its height by a plurality of individual modules stacked one top of one another, with at least two modules having different composites, this individual configuration being implemented for a plurality of cells;
or
a collective configuration, in which each collective module has a plurality of openings allowing each collective module to surround part of a plurality of adjacent electrochemical cells inserted into the openings, according to one of the following two configurations:
the cells are surrounded over their height by a plurality of horizontal collective modules stacked one top of one another, with at least two modules having different composites; or
cells N are surrounded over their entire height by a single Nth vertical collective module composed of a composite N, and cells N+1 adjacent to the cells N are surrounded by a single Nth+1 vertical collective module composed of a composite N+1 that is different from the composite N,
and in which the battery has air and/or liquid micro-exchangers which comprise conductive plates and air and/or liquid microcircuits in the conductive plates allowing compartmentalization of the modules; and regeneration of the PCMs, the micro-exchangers being configured to provide a thermal conduction bridge between the PCMs and carry heat out of the battery.

2. The battery as claimed in claim 1, in which the battery has air and/or liquid micro-exchangers along plates that are advantageously parallel along the length of the PCM modules and/or perpendicular to one another, the plates being in contact with one another in order to carry the heat extracted by the PCMs out of the battery, in particular advantageously with inner plates located between the PCM modules in order to compartmentalize them and which are in contact with perpendicular plates located outside the PCM modules.

3. The battery as claimed in claim 1, in which the exchangers are hybrid exchangers and comprise conductive plates with phase-change materials and microchannels within their thickness.

4. The battery as claimed in claim 1, in which the plates are equipped with a system that controls the direction of flow, with valves to control the flow rates.

5. The battery as claimed in claim 1, in which the plates are equipped with two air/liquid flow circuits or first liquid/second liquid flow circuits.

6. The battery as claimed in claim 1, in which the plates have openings for the electrochemical cells to pass through.

7. The battery as claimed in claim 1, in which the battery comprises one or more compartments for accommodating and fitting to the shape of the modules and electrochemical cells, with:
outer walls which fit to the outer periphery of the modules and
inner walls, the dimensions of which are configured to be in contact, on a first face, with each inner wall of the openings of the modules and, on a second face, with the outer periphery of the electrochemical cells.

8. The battery as claimed in claim 1, in which the shape of the plates is configured:
with openings for the electrochemical cells to pass through and to allow them to be positioned perpendicular to the height of the electrochemical cells in the one or more compartments,
or to allow them to be positioned parallel to the height of the electrochemical cells in the one or more compartments between adjacent electrochemical cells.

9. The battery as claimed in claim 1, in which, when the phase-change material is a solid-liquid phase-change material, said composites are leak-tight, and are selected from among a composite A, a composite B, and a composite C as defined:
a composite A comprising a heat-conducting foam with at least one encapsulated PCM, encased in one or more leak-tight layers or in a composite (B) or in a composite (C),
a composite B comprising a matrix with at least one polymer having heat-conducting fillers and at least one encapsulated PCM,
a composite C comprising a matrix with at least one polymer having at least one PCM micro-encapsulated by at least one heat-conducting material, and which allows the PCM to be contained during its state change.

10. The battery as claimed in claim 1, in which the composites surrounding the electrochemical cells located at the center of the battery are configured to have:
a latent heat greater than the latent heat of the composites located at the edges of the battery; and/or
heat-conducting materials having a heat-conducting capacity greater than the heat-conducting capacity of the heat-conducting materials of the composites located at the edges of the battery.

11. The battery as claimed in claim 1, in which the electrochemical cells are distributed in groups of adjacent electrochemical cells, and, for at least one group of adjacent electrochemical cells, at least two different horizontal collective modules surround all of the adjacent electrochemical cells of this group along their height or part of their height,
the horizontal collective modules being selected for each group of adjacent electrochemical cells according to the following possibilities:
a collective module comprising a composite A and a collective module comprising a composite B; or
a collective module comprising a composite A and a collective module comprising a composite C; or
collective modules comprising a composite B, with variations in composition over the polymer matrices and/or conductive fillers and/or the different PCMs; or
collective modules comprising a composite C, with variations in composition over the polymer matrices and/or different micro-encapsulated PCMs and/or a different heat-conducting micro-encapsulation material.

12. The battery as claimed in claim 1, in which the electrochemical cells are arranged in groups of electrochemical cells,
each group of electrochemical cells having the same vertical collective module over the entire height or part of their height of the group, which is different from another vertical collective module of at least one other group of electrochemical cells over the entire height or part of their height of said group,
the vertical collective modules of composites being selected according to the following possibilities:
a collective module comprising a composite A and a collective module comprising a composite B; or
a collective module comprising a composite A and a collective module comprising a composite C; or
collective modules comprising a composite B, with variations in composition over the polymer matrices and/or conductive fillers and/or the different PCMs; or
collective modules comprising a composite C, with variations in composition over the polymer matrices and/or different micro-encapsulated PCMs and/or a different heat-conducting micro-encapsulation material.

13. The battery as claimed in claim 1, in which the battery has different collective modules in order to provide horizontal and vertical compartments around the electrochemical cells tie.

14. The battery as claimed in claim 1, having a plurality of electrochemical cells, each cell being individually surrounded over its entire height by a module, the composites being selected for each cell according to its location relative to the other electrochemical cells in the battery.

15. The battery as claimed in claim 1, in which the microcircuits differ per module surrounding the electrochemical cells and/or according to the location of one or more electrochemical cells in the module.

16. The battery as claimed in claim 1, in which, alongside a group of electrochemical cells surrounded by a plurality of modules, there is at least one group comprising electrochemical cells without modules.

17. (canceled)

18. The battery as claimed in claim 9, in which:
the heat-conducting foams are selected from the following list: aluminum foams, copper foams, nickel foams, graphite-based foams, all heat-conducting foams; and/or
the conductive fillers or conductive materials encapsulating the PCMs are selected from the following list: fins, expanded graphite, heat-conducting fillers originating from aluminum recycling, copper, aluminum nitride, nano-silica; and/or
the polymers are selected from the following list: HDPE, LDPE, SEBS, SEPS, SEP, PU, PEG, PP, POE, SBS, EPDM, recycled polymers, biopolymers; and/or
the PCMs are selected from the following list: RT paraffins, hexadecane, BioPCM®, PureTemp®, hydrated salts.

19-20. (canceled)

21. The battery as claimed in claim 7, in which the walls of the one or more compartments comprise different materials or a heat-conducting composite, for example these compartments being heat-conducting composites with one or more PCMs or hybrid micro-exchangers (PCM-micro-rings) or air or liquid micro-exchangers.

22. (canceled)

23. The battery as claimed in claim 9, in which the composite B or C has
a blend of polymers:
SEBS and POE;
SBS and EPDM;
HDPE and SBS;
or a blend of polymers selected from the following list:
SEBS, SEPS, SEP, PU, PEG, PP, LDPE, HDPE.

24. A system using a battery as defined in claim 1, in which the electrochemical cells are lithium-ion, lithium-manganese-cobalt (NMC), lithium-polymer (LiPo), lithium-iron-phosphate (LFP), lithium-cobalt-nickel-aluminum (NCA), lithium-manganese (LMO), lithium-titanate (LTO), lithium-air, lithium-cobalt-oxide (LCO), lithium-sulfur (Li—S), lithium-metal-polymer (LMP), lithium-air, or lithium-cobalt-oxide (LCO) cells, or a sodium-ion battery (Na-ion), nickel-cadmium battery (Ni—Cd), or nickel-metal hydride battery (Ni-MH).
